(19) United States
(12) Patent Application Publication
(10) Pub. No.: US 2026/0107936 A1
(43) Pub. Date: Apr. 23, 2026

(54) Rodent Bait Station

(71) Applicant: Dakota Farms LLC, Laurel, DE (US)

(72) Inventor: Nicholas Coverdale, Laurel, DE (US)

(73) Assignee: Dakota Farms LLC, Laurel, DE (US)

(21) Appl. No.: 19/367,666

(22) Filed: Oct. 23, 2025

Related U.S. Application Data
(63) Continuation-in-part of application No. 29/969,602, filed on Oct. 23, 2024.
(60) Provisional application No. 63/710,688, filed on Oct. 23, 2024.

(51) Int. Cl. A01M 25/00

(52) U.S. Cl. CPC A01M 25/004

(57) ABSTRACT

A bait station configured to receive rodenticide and to be mounted on a poultry house feed tube in a deployed configuration. The bait station comprises a pair of oppositely spaced mounting flanges configured to be positioned on opposite sides of the feed tube in the deployed configuration. A tunnel portion having opposite open ends, is connected to the mounting flanges and configured to be positioned above and parallel to the feed tube in the deployed configuration. A bait compartment in communication with the tunnel portion is centrally disposed between the opposite open ends of the tunnel portion and in embodiments may extend from one side of the tunnel portion or may comprise a central region of the tunnel portion. The bait compartment comprises a chamber for receiving the rodenticide through a loading port having a removeable lid.

### CROSS-REFERENCE TO RELATED APPLICATIONS

This application claims priority from U.S. Provisional Application Ser. No. 63/710,688, and is a continuation-in-part of U.S. Design patent application Ser. No. 29/969,602, both of which are titled RODENT BAIT STATION and were filed Oct. 23, 2024, the contents of which are hereby incorporated by reference.

### BACKGROUND OF THE INVENTION

One of the main problems trying to control rodents in a poultry operation is when birds have been removed from the house, rodents then use that opportunity to travel the feed lines and eat feed remaining in the poultry feed trays.

Poultry house feeding systems known in the art, such as systems made by CTB, Inc. d/b/a Chore-Time® and described in U.S. Pat. No. 3,230,933, incorporated herein by reference. These feeding systems typically include a plurality of feeding pans each suspended by a hanger from a tube, inside which is an auger that rotates to moves feed from a storage hopper (e.g. a feed box fed from a silo) through the tube to holes in the tube aligned over the pans that discharge feed into the pans. A wire, in tension, runs parallel to and vertically spaced above the tube and serves to restrain the hanger from rotating relative to the tube. Historically, in at least some systems, this wire have been (and may still be, in some installations) energized to provide a shock of suitable magnitude to discourage a bird from sitting on the feed tube without harming the bird. The feed lines may be configured to be raised and lowered to accommodate different sizes of poultry and may rest in a highest raised position when no poultry are present (for ease of cleaning of the floors below), and in a lowest position when newly hatched chicks are in the house.

Thus, in an empty poultry house, rodents can travel from outside the house along the feed tubes, then drop into the pan to eat leftover food. Accordingly, there is a need in the art for systems and methods for reducing and/or eliminating rodents who learn this pathway to obtaining food.

### SUMMARY OF THE INVENTION

One aspect of the invention relates to a bait station configured to receive rodenticide and to be mounted on a poultry house feed tube in a deployed configuration of the bait station. The bait station comprises a pair of oppositely spaced mounting flanges configured to be positioned on opposite sides of the feed tube with the bait station in the deployed configuration, a tunnel portion having opposite open ends, the tunnel portion connected to the mounting flanges and configured to be positioned above and parallel to the feed tube in the deployed configuration, and a bait compartment in communication with the tunnel portion. The bait compartment is centrally disposed between the opposite open ends of the tunnel portion and in embodiments may extend from one side of the tunnel portion or may comprise a central region of the tunnel portion. The bait compartment comprises a chamber for receiving the rodenticide through a loading port having a removeable lid.

A curb may be disposed between the tunnel portion (or remaining portion of the tunnel portion) and the bait compartment for retaining the rodenticide from exiting the bait compartment into the tunnel portion. In embodiments, the bait compartment may be configured to receive a bait block of rodenticide.

The removeable lid may have one or more biasing flanges configured to exert a bias on an interior of the loading port with the lid in a closed position, such as biasing flanges having an outward protrusion positioned to align with a mating indent in the loading port interior. The removeable lid may further have at least one tab extending peripherally from the lid and may have at least one through-hole.

In embodiments in which the poultry house feed tube has a wire disposed above the feed tube running parallel to the feed tube, the bait station may have a spacer connecting the mounting flanges to the tunnel portion, in which the spacer has a groove parallel to the tunnel portion for receiving the wire, such as in a position in which the wire restrains the bait station from rotating relative to the tube.

The oppositely spaced mounting flanges may each have an interior surface and an exterior surface, wherein an interior dimension between the respective interior surfaces of the flanges with the bait station in a non-deployed configuration is less than an outer dimension of the feed tube, in which the bait station comprises a flexible, resilient material, such that the flanges exert a compressive bias against the feed tube with the bait station in the deployed configuration. Each flange has a lengthwise dimension disposed parallel to the feed tube, and the outer surfaces of the flanges may have a plurality of protrusions, including at least one protrusion adjacent each end of the lengthwise dimension of each flange, each protrusion having an opening.

Another aspect of the invention includes a method for reducing a rodent population in a poultry house, the method comprising the steps of (a) providing the bait station as described herein, (b) installing the bait station on a top side the feed tube, (c) disposing a rodenticide in the bait compartment through the loading port, and (d) closing the lid on the bait compartment. In embodiments, steps (c) and (d) may be performed only when the poultry house is unoccupied by poultry. In embodiments, the method may include installing the bait station when the poultry house is unoccupied by poultry, and removing the bait station when the poultry house is occupied by poultry.

In embodiments, each flange has a lengthwise dimension disposed parallel to the feed tube in the deployed configuration and the outer surfaces of the flanges comprise a plurality of protrusions, including at least one protrusion positioned adjacent each end of the lengthwise dimension of each flange, each protrusion having an opening. In such embodiments, the step of installing the bait station on the feed tube comprises disposing a first fastening member through the respective openings of the protrusions located on the opposite flanges at a first end of the bait station, and disposing a second fastening member through the respective openings of the protrusions located on the opposite flanges at a second end of the bait station, wherein each fastening member traverses an underside of the pipe between the connected protrusions.

In embodiments wherein the lid on the bait compartment further comprises one or more biasing flanges comprises an outward protrusion positioned to align with a mating indent in the loading port interior, the step of closing the lid on the bait compartment includes securing the lid on the loading port with the outward protrusions of the biasing flanges positioned in the mating indents.

In embodiments wherein the lid further comprises at least one tab extending peripherally from the lid, the at least one tab further comprising at least one through-hole, the method includes connecting the lid to the bait station or a structure adjacent the bait station installed on the feed tube by attaching one portion of a line to the bait station the through-hole and fastening another portion of the line to the bait station or the adjacent structure.

### BRIEF DESCRIPTION OF THE DRAWINGS

FIG. 1A depicts a top view of an exemplary bait station first embodiment.

FIG. 1B depicts a side view of the exemplary bait station embodiment of FIG. 1A.

FIG. 1C depicts a top, bait compartment side, perspective view of the exemplary bait station embodiment of FIG. 1A.

FIG. 1D depicts a cross section of the exemplary bait station embodiment of FIG. 1A taken along arrow A-A shown in FIG. 1B.

FIG. 1E depicts a top, non-bait-compartment side, perspective view of the exemplary bait station embodiment of FIG. 1A.

FIG. 2A depicts a top perspective view of an exemplary removeable lid for the exemplary bait station embodiment of FIG. 1A.

FIG. 2B depicts a bottom perspective view of the exemplary removeable lid of FIG. 2A.

FIG. 2C depicts a side view of the exemplary removeable lid of FIG. 2A.

FIG. 2D depicts a plan view of the exemplary removeable lid of FIG. 2A.

FIG. 2E depicts a cross-sectional view of the exemplary removeable lid of FIG. 2A, taken along arow A-A shown in FIG. 2D.

FIG. 3A depicts an exemplary bait station embodiment mounted on an exemplary feed tube of a poultry feed system, taken from the non-bait-compartment side perspective at a first end of the bait station.

FIG. 3B depicts the exemplary bait station embodiment mounted on the exemplary feed tube of FIG. 3A, taken from a top perspective at the first end.

FIG. 3C depicts the exemplary bait station embodiment mounted on the exemplary feed tube of FIG. 3A, taken from the bait compartment side perspective at a second end of the bait station.

FIG. 4A depicts a top view of an exemplary bait station second embodiment.

FIG. 4B depicts a side view of the exemplary bait station embodiment of FIG. 4A.

FIG. 4C depicts a top, right side perspective view of the exemplary bait station embodiment of FIG. 4A.

FIG. 4D depicts a longitudinal section of the exemplary bait station embodiment of FIG. 4A taken along arrow D-D shown in FIG. 4B.

FIG. 4E depicts a top left side perspective view of the exemplary bait station embodiment of FIG. 1A.

FIG. 5A is a front top perspective view of an exemplary rodent bait station embodiment consistent with FIGS. 4A-4E.

FIG. 5B is a front plan view of the exemplary rodent bait station embodiment of FIG. 5A.

FIG. 5C is a rear plan view of the exemplary rodent bait station embodiment of FIG. 5A.

FIG. 5D is a right side plan view of the exemplary rodent bait station embodiment of FIG. 5A.

FIG. 5E is a left side plan view of the exemplary rodent bait station embodiment of FIG. 5A.

FIG. 5F is a top plan view of the exemplary rodent bait station embodiment of FIG. 5A.

FIG. 5G is a bottom plan view of the exemplary rodent bait station embodiment of FIG. 5A.

FIG. 5H is an exploded top perspective view of the exemplary rodent bait station embodiment of FIG. 5A, depicting features of the lid in a removed configuration.

### DETAILED DESCRIPTION OF THE INVENTION

Described herein is a rodent bait station designed to rest on top of a poultry house feed line system. The bait station as described herein attached to feed lines disposes a controlling substance in the path of rodents to help subdue the infestation of rodents while also keeping the controlling substance confined to the bait station without allowing contamination of the poultry operation.

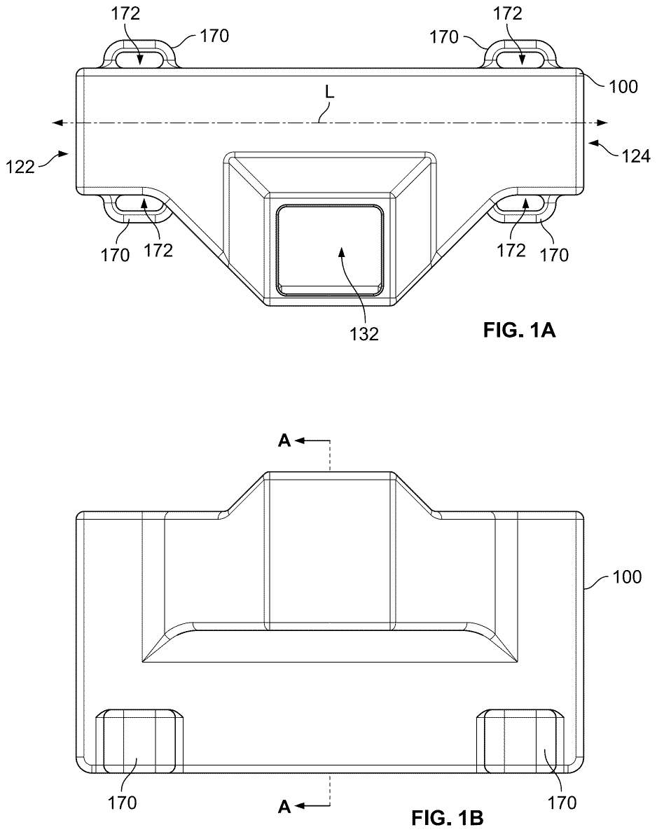

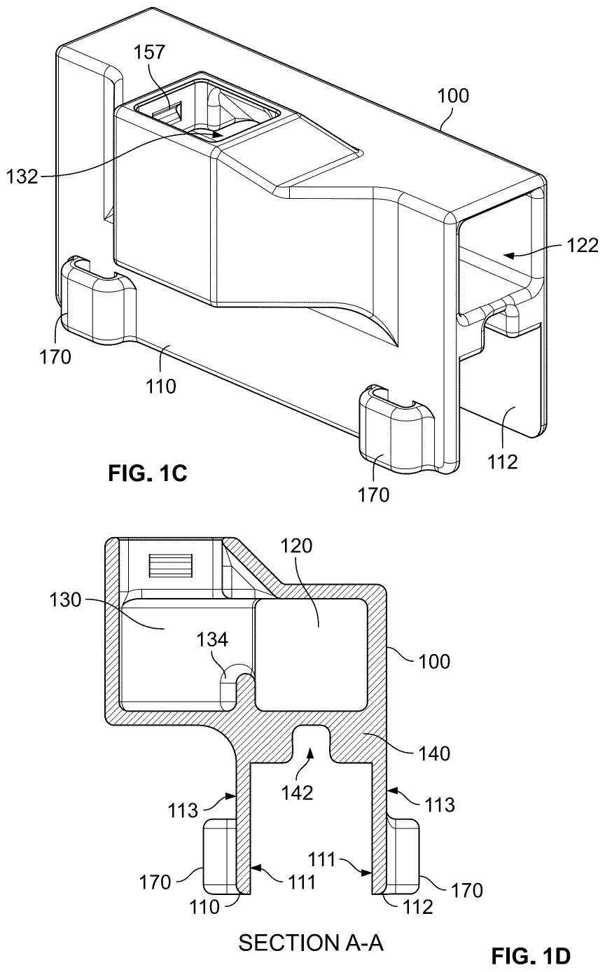

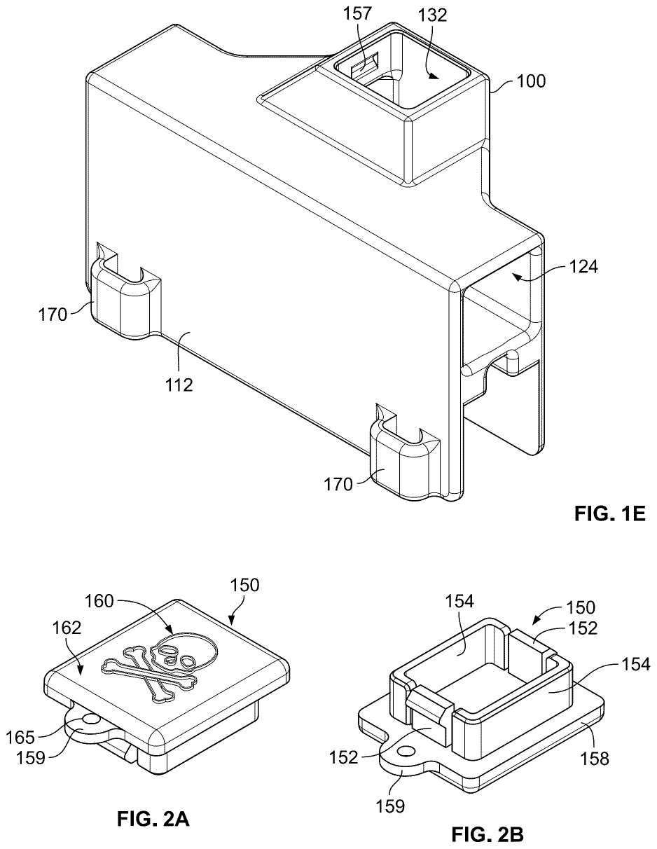

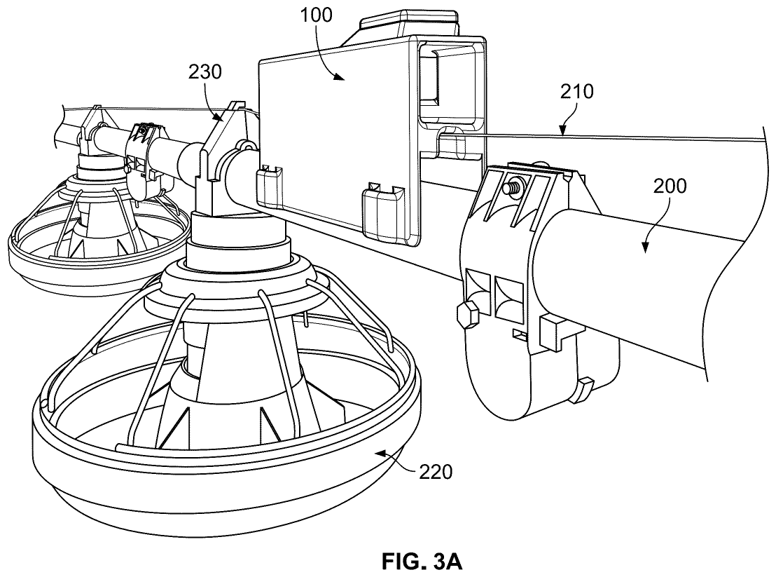

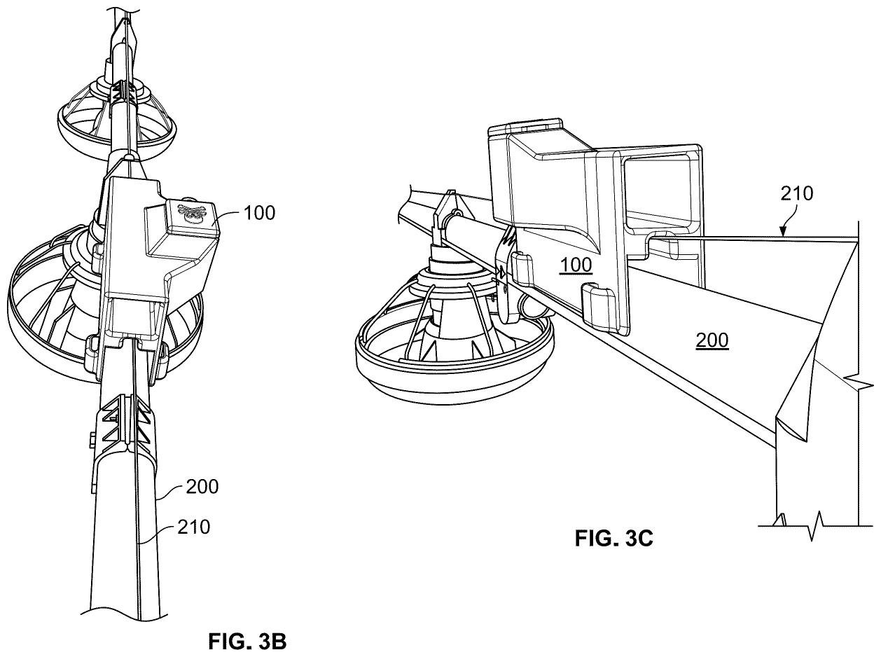

In exemplary embodiments, depicted in FIGS. 1A-5H, bait station 100, 400 is configured to be mounted on a poultry house feed tube 200 in a deployed configuration (such as is depicted for embodiment 100 in FIGS. 3A-3C). As depicted in FIGS. 3A-3C, a plurality of feeding pans 220 are each suspended by a hanger 230 from feed tube 200, with wire 210 running parallel to and vertically spaced above the tube to restrain the hanger from rotating relative to the tube.

The exemplary bait station 100, 400 comprises a pair of oppositely spaced mounting flanges 110, 112 or 410, 412, respectively configured to be positioned on opposite sides of the feed tube 200 with the bait station in the deployed configuration. A tunnel portion 120 runs along axis L that is configured to be positioned above and parallel to the feed tube when the bait station is in the deployed configuration. Tunnel portion 120 connected to the mounting flanges by spacer 140, has opposite open ends 122, 124 (422, 42$). Spacer 140 connects the mounting flanges 110, 112 to the tunnel portion 120, and defines the floor of the tunnel as well as the dimension by which the flanges are spaced apart from another. A bait compartment 130, 430 is in communication with the tunnel portion. The bait compartment is centrally disposed between the opposite open ends of the tunnel portion.

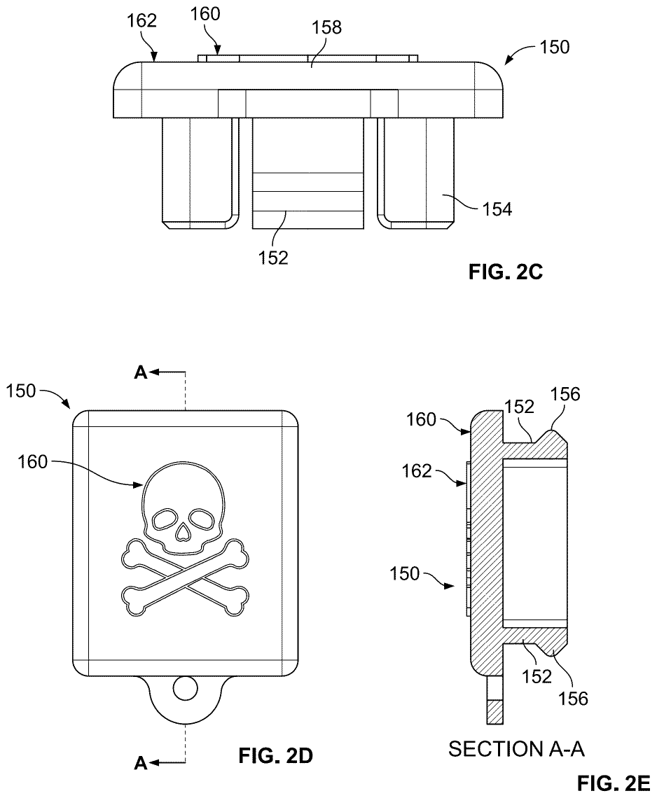

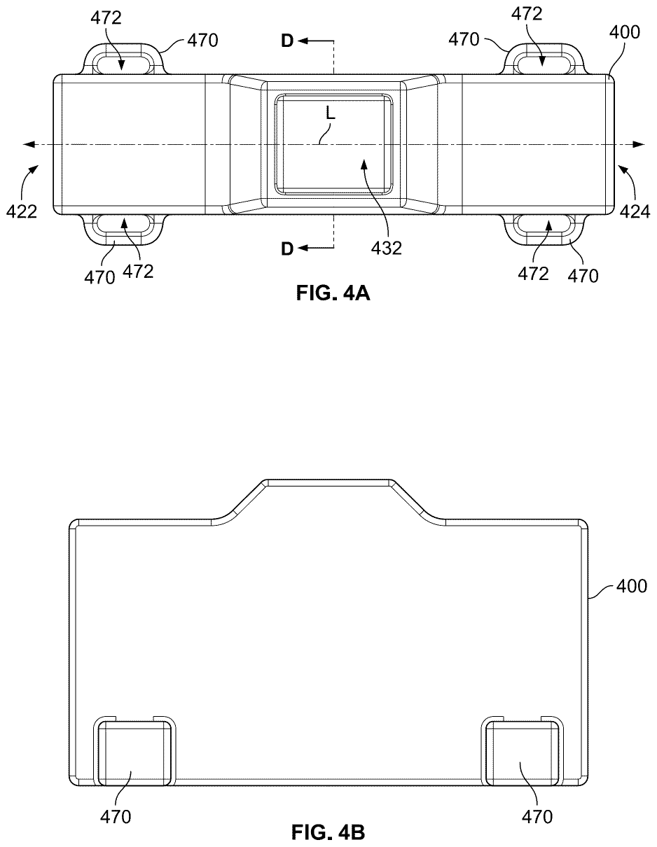

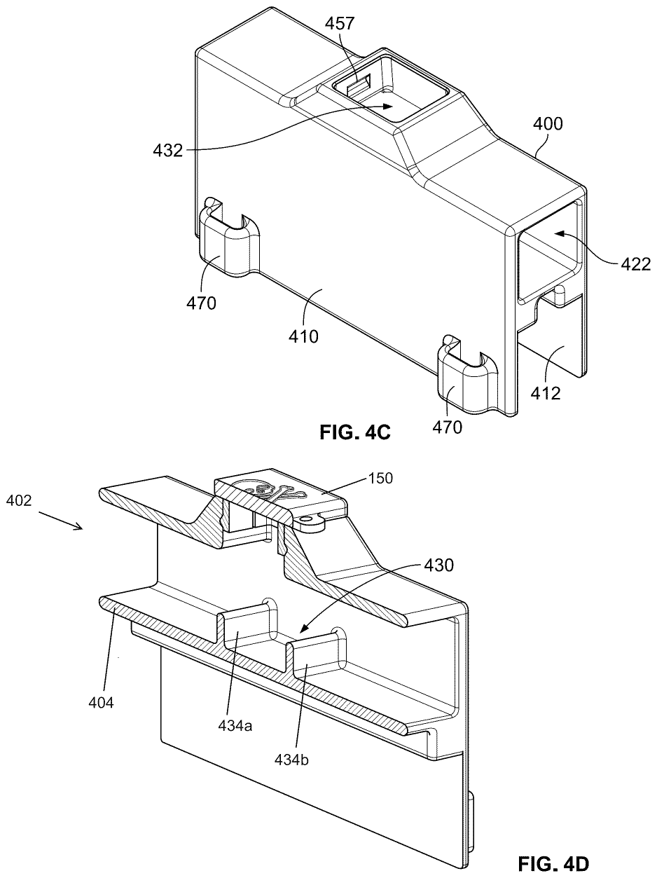

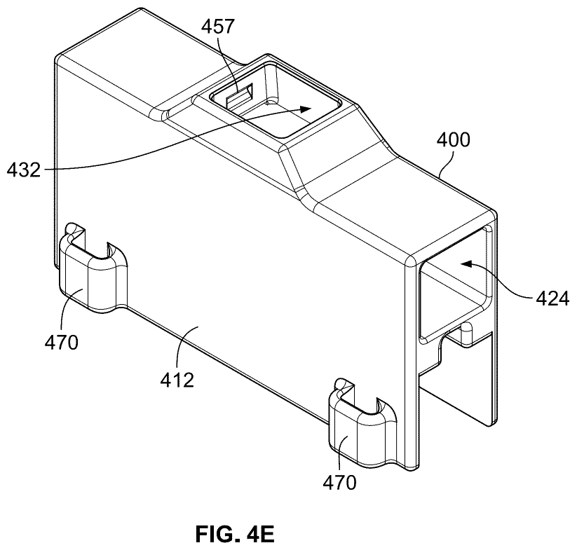

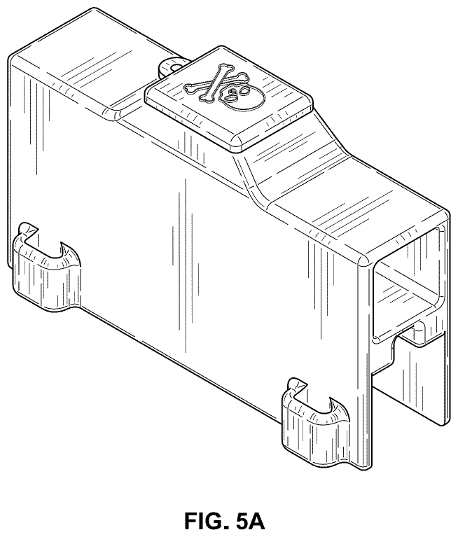

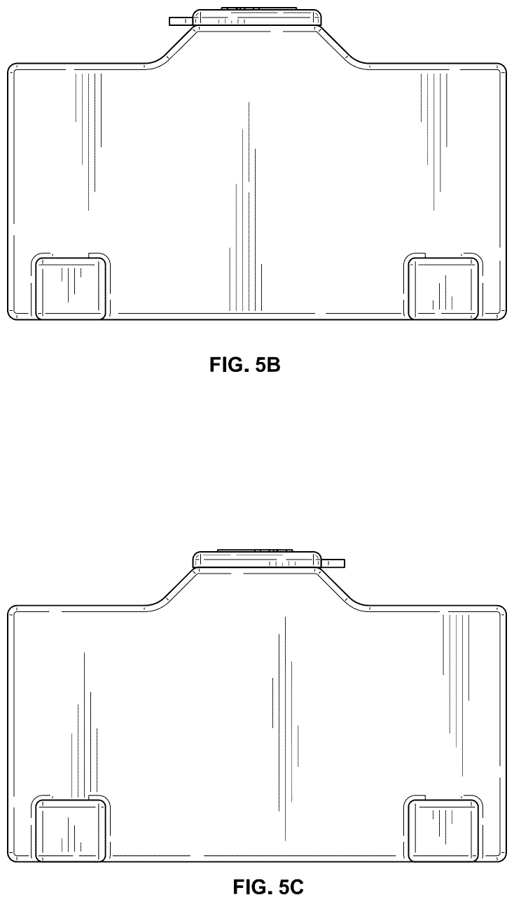

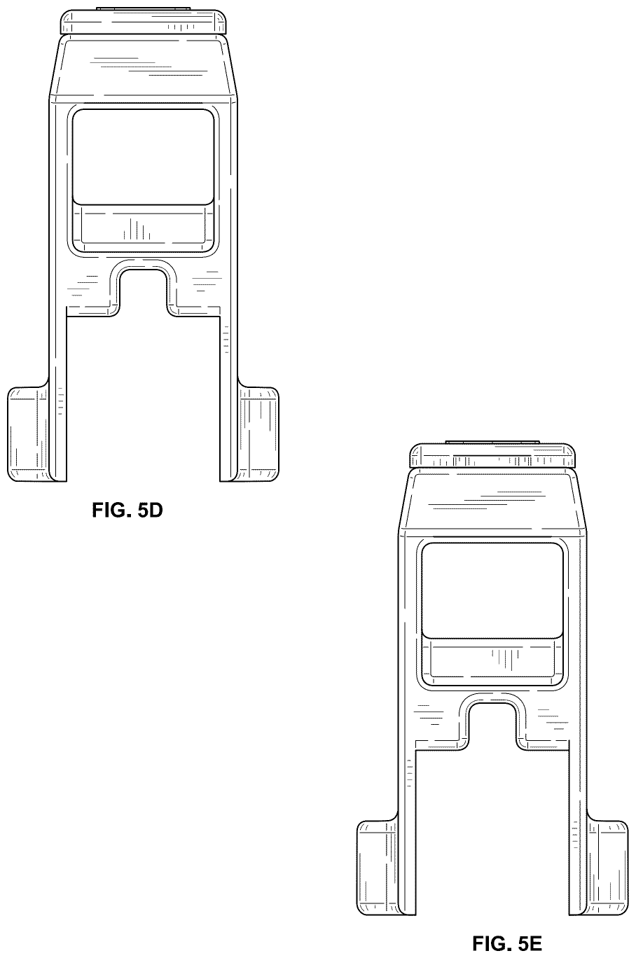

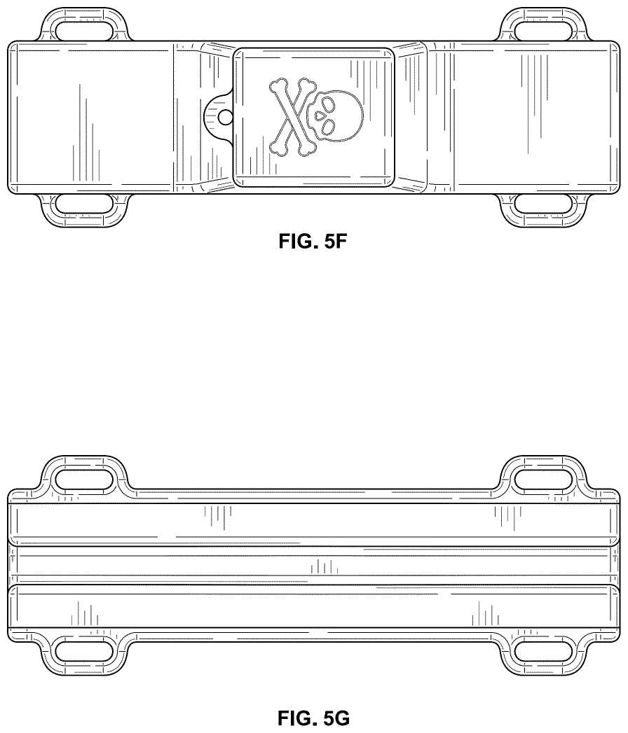

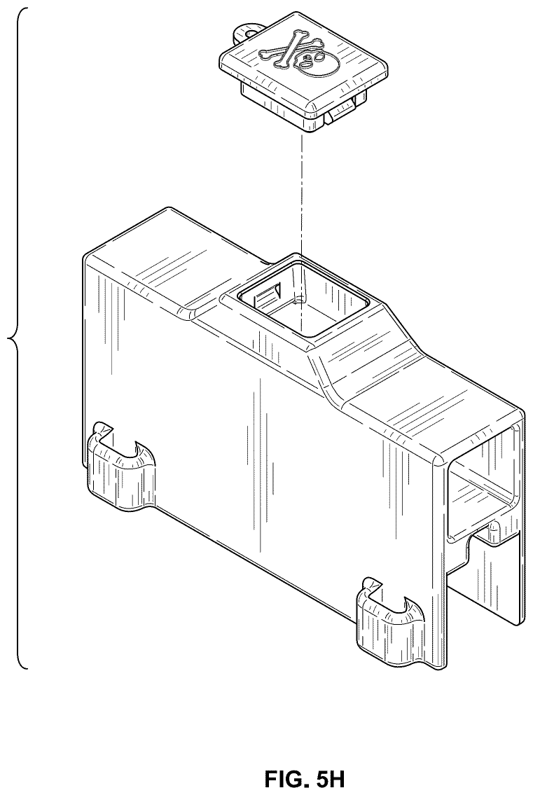

In the embodiment depicted in FIGS. 1A-1E, bait compartment 130 extends from one side of the tunnel portion. In the embodiment depicted in FIGS. 4A-4E and FIGS. 5A-5H, bait compartment 430 comprises a central portion of the tunnel portion. The bait compartment includes a chamber for receiving rodenticide, such as a bait block (not shown), and is configured to be loaded with the rodenticide through a loading port 132, 432 having a removeable lid 150, such as is depicted in more detail in FIGS. 2A-2E. One or more curbs 134, 434a, 434b may be disposed between the bait compartment and the opposite ends of the tunnel portion for retaining the rodenticide from exiting the bait compartment into the tunnel portion. In the embodiment depicted in FIGS. 1A-1E, a singular curb is disposed between the bait compartment and the tunnel. In the embodiment depicted in FIGS. 4A-4E, one curb is disposed between the bait compartment portion of the tunnel and each opposite end of the tunnel portion. In the embodiments as depicted, the loading port 132, 432 extends vertically above the tunnel, primarily to provide room to accommodate a lid that can be fastened securely without reducing the enclosure space of the bait compartment, as described further herein.

In embodiments in which the poultry house feed tube has a wire 210 disposed above the feed tube 200 running parallel to the feed tube, spacer 140 may have a groove 142 that runs parallel to the tunnel portion for receiving the wire. When the bait station is installed on the feed tube, wire 210 is disposed in the groove 142 such that the wire restrains the bait station from rotating relative to the tube, because of interactions between the wire and the sidewalls of the groove. Although depicted as having a C-shaped cross section, the groove may have any geometric configuration. Although depicted in FIGS. 3A-3C showing the embodiment as depicted in FIGS. 1A-1E deployed in a poultry house, those of skill in the art will understand that the embodiment as depicted in FIGS. 4A-4E may be similarly deployed. Likewise, one of skill in the art will understand that to the extent certain components labeled and described with respect to the embodiment shown in FIGS. 1A-1E may not have corresponding labels or descriptions for the analogous features in the embodiment shown in FIGS. 4A-4E, the similar or analogous elements in the respective sets of figures have the same names and same general locations (e.g. tunnel, spacer, groove, etc.).

Removeable lid 150 may have one or more biasing flanges 152 configured to make contact with and exert a bias on an interior of the loading port 132 with the lid in a closed position. As shown, biasing flanges 152 are moveable relative to interior walls 154 of the lid and include protrusions 156 for making contact with mating indents 157, 457 in the corresponding interior walls of the loading port 132, 432. Lid 150 has a cover portion 158 that has a greater periphery than the periphery defined by the interior walls 154 and the biasing flanges 152. At least one tab 159 extends peripherally from the cover portion of the lid. This tab may to helpful to a user who needs to exert a force to pry the lid off, and may have a through-hole 165, such as to receive a line (e.g. wire, monofilament, string) for tying the lid to the station or a surrounding structure to avoid loss of the lid when removed. The cover portion 158 may optionally comprise informational indicia 160, such as a skull and bones universally understood to indicate poison located inside, which indicia may be raised or indented relative to the top surface 161 of the cover portion. Other informational indicia may also be disposed on the bait station, such as by molding or 3D printing raised or indented characters or designs into various portions of the plastic bait station, or by printing information with ink or adhesively attaching labels, without limitation.

While both the embodiments as depicted herein may have various advantages, one advantage of the embodiment as depicted in FIGS. 4A-5H is that the shape as depicted in FIG. 4C can be formed using two body portions 402 resembling the geometry of FIG. 4D. Although FIG. 4D is shown as a cross section, it should be understood that the entire body portion 402 as depicted (excluding the portion of lid 150 depicted therein) can be formed in a single mold, and that two body portions may be combined together as mirror images (e.g. with an adhesive between abutting edges to attach them together) to form the whole body depicted in FIG. 4C. thereby allowing the bait station to be formed using a single mold for making both the left and right sides before assembly (and then another mold for forming the lid). The manufacture of the bait station as depicted is not limited to use of molding techniques, however, and may include 3D printing or other additive manufacturing techniques. The body portion 402 as shown may also include one or more protrusions and mating cavities (not shown) disposed on any of the edges 404 (including all lined portions as illustrated) with protrusions on one side (i.e. right or left) symmetrically aligned with corresponding cavities (i.e. left or right) such that the respective protrusions align with mating cavities when the mirror-image body portions are combined together with one another, as would be understood to those of skill in the art.

The oppositely spaced mounting flanges 110, 112 each have a respective interior surface 111 and a respective exterior surface 113. An interior dimension between the respective interior surfaces of the flanges with the bait station in a non-deployed configuration may be the same, or even slightly less than, an outer dimension of the feed tube, and the bait station may comprise a flexible, resilient material, such that the flanges exert at least a slight compressive bias against the feed tube when the bait station in the deployed configuration. For example, in an embodiment in which a steel pipe feed tube has a nominal 1¼ inch diameter, the outside diameter (O.D.) may actually be 1.66 inches, and the spacing between the interior surfaces of the flanges in the non-deployed configuration may be 1.625 inches (e.g. approximately 98% of the outer diameter of the tube, with a range of 95-100% being an exemplary range). As depicted, each flange has a lengthwise dimension disposed parallel to the feed tube, and the outer surfaces of the flanges comprise a plurality of protrusions 170, 470 including at least one protrusion adjacent each end of the lengthwise dimension of each flange, each protrusion having an opening 172, 472. As depicted, the openings 172, 472 run vertically and are open at both a top and bottom end, giving each protrusion the geometry of a loop. These openings may be used by the installer to secure a fastening member (e.g. a zip-tie; metal wire or non-metal line or band), not shown, through the openings in the protrusions on opposite flanges at each end to secure the bait station to the underside of the pipe. For example, a first fastening member may be threaded through the respective openings of the protrusions located on the opposite flanges at a first end of the bait station, and a second fastening member may be threaded through the respective openings of the protrusions located on the opposite flanges at a second end of the bait station, with each fastening member traversing the underside of the pipe between the connected protrusions.

Aspects of the invention also include methods for reducing a rodent population in a poultry house. The method includes the steps of providing a bait station as described herein, installing the bait station on the feed tube, disposing the rodenticide in the bait compartment through the loading port; and closing the lid on the bait compartment. The method may include only loading (and retaining) the bait in the bait station when the poultry house is unoccupied by poultry. In some embodiments, the method may include installing the bait station when the poultry house is unoccupied by poultry and removing the bait station when the poultry house is occupied by poultry. The invention is not limited to any particular mode of operation and may be operated in any mode that may be required by a regulatory agency (e.g. the United States (US) Environmental Protection Agency (EPA) and/or US Department of Agriculture (USDA), or equivalent agencies in other local, state, provincial, or federal jurisdictions).

While discussed herein as being optimized for use with a “bait block” style bait (e.g. comprising Bromethalin), such as made by JT Eaton, the invention is not limited to use of any type, chemical compound, or geometry of rodenticide. However, bait blocks have the advantage of being easier to contain within the bait containment section as compared to smaller rodenticide formats (e.g. granules or nuggets), which might otherwise fall into the tunnel portion and ultimately make their way out onto the poultry house floor. Additionally, the centrally located, offset positioning of the bait containment section, dimensions of the tunnel open ends and/or dimensions of the connecting area between the tunnel and the bait containment area may be optimized to establish a distance from the openings at each end of the tunnel to the containment area that physically limits a typical bird from being able to reach the poison with its beak. For example, in the embodiment depicted, the inner dimensions of the tunnel have a 1.5 inch square cross section, and the distance from each open end of the tunnel to the edge of the bait containment section is approximately 3.2 inches. Although depicted as a tunnel having a square cross section, the invention is not limited to any particular geometry or dimensions of the tunnel.

In operation, a rodent running along the feed tube will encounter the bait station prior to reaching any of the feeding pans and will be tempted by the aroma of the bait to enter the bait station. There, the rodent will consume the bait and will eventually (e.g. within 1-2 days) succumb to the effects of the poison, even after only a single feeding.

Although described herein in an embodiment for use in a poultry house, especially chicken houses, the invention is not limited to any particular type of animal husbandry.

Method for manufacturing the bait station may comprise injection molding, additive manufacturing, or the like. The bait station is not limited to any particular materials of construction, but in embodiments may preferably comprise any suitable plastic material known in the art (e.g. PVC, ABS, PET, PETG, PC, PP, PLA, ASA, PEEK, PEKK, ULTEM) as well as composites or hybrid materials, without limitation.

The embodiment of the invention as shown in FIGS. 1A-1E and described herein is also the subject of U.S. design patent application Ser. No. 29/969,602, having a common priority date, title, and applicant as the present application, the contents of which are incorporated herein by reference hereinabove. Additionally, this application, and particularly FIGS. 5A-5H may support a second design application to the second embodiment as referenced herein. It should be understood that certain aspects of both embodiments may also support a single design application drawn with elements common to both embodiments depicted in solid lines and elements not common to both embodiments depicted in dashed lines. Embodiments of the respective designs may include fewer than all of the features as described herein. As should be understood by one of skill in the art, embodiments of the invention as described and claimed herein may take any number of aesthetic forms with any number of features having geometries and other attributes that are not dictated by function in whole or in part, not limited to the form shown in the figures of this application (or in any respective design patent applications), and may include embodiments with fewer or more features than depicted, and with geometries different than as depicted, without limitation.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A bait station configured to receive rodenticide and configured to be mounted on a poultry house feed tube in a deployed configuration of the bait station, the bait station comprising:
a pair of oppositely spaced mounting flanges configured to be positioned on opposite sides of the feed tube with the bait station in the deployed configuration;
a tunnel portion having opposite open ends, the tunnel portion connected to the mounting flanges and configured to be positioned above and parallel to the feed tube in the deployed configuration;
a bait compartment in communication with the tunnel portion, the bait compartment centrally disposed between the opposite open ends of the tunnel portion the bait compartment comprising a chamber for receiving the rodenticide through a loading port having a removeable lid.

2. The bait station of claim 1, comprising one or more curbs disposed between the bait compartment and the opposite open ends of the tunnel portion for retaining the rodenticide within the bait compartment.

3. The bait station of claim 1, wherein the bait compartment is configured to receive a bait block of rodenticide.

4. The bait station of claim 1, wherein the removeable lid comprises one or more biasing flanges configured to exert a bias on an interior of the loading port with the lid in a closed position.

5. The bait station of claim 1, wherein the one or more biasing flanges comprises an outward protrusion positioned to align with a mating indent in the loading port interior.

6. The bait station of claim 1, wherein the removeable lid further comprises at least one tab extending peripherally from the lid.

7. The bait station of claim 6, wherein the at least one tab extending peripherally from the lid further comprises at least one through-hole.

8. The bait station of claim 1, wherein the bait station is configured to be deployed on a poultry house feed tube having a wire disposed above the feed tube running parallel to the feed tube, the bait station further comprising a spacer connecting the mounting flanges to the tunnel portion, the spacer having a groove parallel to the tunnel portion for receiving the wire.

9. The bait station of claim 8, wherein the groove is configured to receive the wire in a position in which the wire restrains the bait station from rotating relative to the tube.

10. The bait station of claim 1, wherein the oppositely spaced mounting flanges each have an interior surface and an exterior surface, and an interior dimension between the respective interior surfaces of the flanges with the bait station in a non-deployed configuration is less than an outer dimension of the feed tube, the bait station comprising a flexible, resilient material, such that the flanges exert a compressive bias against the feed tube with the bait station in the deployed configuration.

11. The bait station of claim 10, wherein each flange has a lengthwise dimension disposed parallel to the feed tube, and the outer surfaces of the flanges comprise a plurality of protrusions, including at least one protrusion adjacent each end of the lengthwise dimension of each flange, each protrusion having an opening.

12. A method for reducing a rodent population in a poultry house, the method comprising the steps of:
(a) providing a bait station of claim 1;
(b) installing the bait station on a top side the feed tube;
(c) disposing a rodenticide in the bait compartment through the loading port; and
(d) closing the lid on the bait compartment.

13. The method of claim 12, wherein steps (c) and (d) are performed only when the poultry house is unoccupied by poultry.

14. The method of claim 12, further comprising installing the bait station when the poultry house is unoccupied by poultry, and removing the bait station when the poultry house is occupied by poultry.

15. The method of claim 12, wherein the poultry house feed tube has a wire disposed above the feed tube running parallel to the feed tube, the bait station further comprising a spacer connecting the mounting flanges to the tunnel portion, the spacer having a groove parallel to the tunnel portion for receiving the wire, wherein the bait station is installed on the feed tube with the wire disposed in the groove such that the wire restrains the bait station from rotating relative to the tube.

16. The method of claim 12, wherein the oppositely spaced mounting flanges of the bait station each have an interior surface and an exterior surface, and an interior dimension between the respective interior surfaces of the flanges with the bait station in a non-deployed configuration is less than an outer dimension of the feed tube, the bait station comprising a flexible, resilient material, wherein the flanges exert a compressive bias against the feed tube with the bait station in the deployed configuration.

17. The method of claim 16, wherein each flange has a lengthwise dimension disposed parallel to the feed tube in the deployed configuration and the outer surfaces of the flanges comprise a plurality of protrusions, including at least one protrusion positioned adjacent each end of the lengthwise dimension of each flange, each protrusion having an opening, and the step of installing the bait station on the feed tube comprises disposing a first fastening member through the respective openings of the protrusions located on the opposite flanges at a first end of the bait station, and disposing a second fastening member through the respective openings of the protrusions located on the opposite flanges at a second end of the bait station, wherein each fastening member traverses an underside of the pipe between the connected protrusions.

18. The method of claim 12, wherein the lid on the bait compartment further comprises one or more biasing flanges comprises an outward protrusion positioned to align with a mating indent in the loading port interior, where the step of closing the lid on the bait compartment includes securing the lid on the loading port with the outward protrusions of the biasing flanges positioned in the mating indents.

19. The method of claim 12, wherein lid on the bait compartment further comprises at least one tab extending peripherally from the lid, the at least one tab further comprising at least one through-hole, wherein the method includes connecting the lid to the bait station or a structure adjacent the bait station installed on the feed tube, by attaching one portion of a line to the bait station the through-hole and fastening another portion of the line to the bait station or the adjacent structure.

20. The bait station of claim 1, wherein the bait compartment extends from one side of the tunnel portion.

21. The bait station of claim 20, further comprising a singular curb disposed between the bait compartment and the tunnel portion for retaining the rodenticide within the bait compartment.

22. The bait station of claim 1, wherein the bait compartment comprises a central region of the tunnel portion.

23. The bait station of claim 22, further comprising two curbs disposed between the bait compartment and the opposite open ends of the tunnel portion for retaining the rodenticide within the bait compartment, including a first curb disposed between the bait compartment and a first opposite end, and a second curb disposed between the bait compartment and a second opposite end.
